(19) United States
(12) Patent Application Publication
(10) Pub. No.: US 2023/0302946 A1
(43) Pub. Date: Sep. 28, 2023

(54) SYSTEMS AND METHODS FOR COLLISION DETECTION USING AN ELECTRIC VEHICLE CHARGING STATION

(71) Applicant: Volta Charging, LLC, San Francisco, CA (US)

(72) Inventors: Jeffrey Kinsey, San Mateo, CA (US); Ramsey Meyer, San Francisco, CA (US); Michael Clement, Monterey, CA (US)

(21) Appl. No.: 17/989,017

(22) Filed: Nov. 17, 2022

Related U.S. Application Data
(60) Provisional application No. 63/282,990, filed on Nov. 24, 2021.

(51) Int. Cl. B60L 53/66; B60L 53/68

(52) U.S. Cl. CPC B60L 53/66; B60L 53/68; B60L 2270/00; B60L 2250/10

(57) ABSTRACT

Systems and methods are provided herein for detecting a collision event and taking measures to reduce resulting damage and injury. This may be accomplished by an electric vehicle charging station (EVCS) receiving power from a first power source, wherein the EVCS uses the power to charge an electric vehicle. The EVCS can use a sensor to detect an object within a threshold distance of the EVCS. The EVCS can use the information collected by the sensor to determine if the object will contact the EVCS. If the EVCS determines that the object will contact the EVCS the EVCS can take measures (e.g., stop receiving power from the power source) to reduce damage and/or injury.

### CROSS-REFERENCE TO RELATED APPLICATION

This disclosure claims the benefit of U.S. Provisional Patent Application No. 63/282,990, filed Nov. 24, 2021, which is hereby incorporated by reference herein in its entirety.

### BACKGROUND

The present disclosure relates to computer-implemented techniques for detecting collision events between objects and electric vehicle charging stations, and in particular to techniques for reducing dangerous conditions during collision events.

### SUMMARY

As more consumers transition to electric vehicles, there is an increasing demand for electric vehicle charging stations (EVCSs). These EVCSs usually supply electric energy, either using cables or wirelessly, to the batteries of electric vehicles. For example, a user can connect their electric vehicle via cables of an EVCS, and the EVCS supplies electrical current to the user's electric vehicle. The cables and control systems of the EVCSs can be housed in kiosks in locations to allow a driver of an electric vehicle to park the electric vehicle close to the EVCS and begin the charging process. These kiosks may be placed in areas of convenience, such as in parking lots at shopping centers, in front of commercial buildings, or in other public places. Whether it be a distracted driver or a rogue shopping cart, EVCSs sometimes experience collision events. A collision event is whenever an external object comes into contact with an EVCS, where the contact can cause damage to the EVCS or the external object. These events can result in damage to people, EVCSs, and the surrounding environment. Current EVCSs lack the ability to anticipate a collision and mitigate negative consequences. In view of these deficiencies, there exists a need for improved systems and methods for detecting a collision event before it occurs and taking measures to reduce resulting damage and injury.

Various systems and methods described herein address these problems by detecting a collision event and taking measures to reduce resulting damage and injury. As described herein, one methodology for an EVCS to detect a collision event is for the EVCS to use one or more sensors to collect information relating to the area proximal to the EVCS. For example, these sensors may be image sensors (e.g., one or more cameras), ultrasound sensors, depth sensors, infrared (IR) cameras, red green blue (RGB) cameras, passive IR (PIR) cameras, proximity sensors, radar, tension sensors, near field communication (NFC) sensors, and/or any combination thereof. The sensors may be housed within the kiosk of the EVCS and/or may be located in the area around the EVCS. Some sensors may constantly record proximal information and/or may be requested to record proximal information in response to some input. For example, if the EVCS determines that an object is within a first distance (e.g., two feet) of the EVCS, the EVCS may request additional proximal information. The EVCS can process the proximal information recorded by the one or more sensors to determine if a collision event is likely to take place. For example, a first sensor (e.g., a camera) may record a vehicle approaching the EVCS. The EVCS can receive the proximal information recorded by the camera and determine if the vehicle approaching the EVCS is likely to contact the EVCS.

Not all proximal information corresponding to objects approaching the EVCS corresponds to collision events. Some objects (e.g., vehicles) approaching the EVCS will stop before there is any likelihood of a collision. For example, a vehicle may be approaching the EVCS and stop 20 feet away from the EVCS before turning away from the EVCS. Accordingly, the EVCS may use a threshold distance to determine if a collision event is likely to occur. The threshold distance may vary depending on the speed of the object. For example, the EVCS may use a first threshold distance (e.g., 30 feet) for a vehicle traveling a first speed (e.g., 50 miles per hour) toward the EVCS and may use a second threshold distance (e.g., two feet) for a second vehicle traveling a second speed (e.g., five miles per hour) toward the EVCS. The EVCS may also use proximal information corresponding to attributes of the object (e.g., type of object, speed of the object, etc.) to determine the likelihood of a collision event. For example, the EVCS may determine that a person who is two feet away approaching the EVCS at five miles per hour does not correspond to a collision event, but a vehicle two feet away approaching the EVCS at five miles per hour does correspond to a collision event.

The EVCS may request information from more than one sensor when determining the likelihood of a collision event. For example, a magnetic field sensor (first sensor) may record proximal information indicating a collision event, and the EVCS may use proximal information from a camera to confirm or dispute whether the collision event is likely to occur. The EVCS may use proximal information from one or more sensors to determine a collision event confidence score. The EVCS may issue commands based on the confidence score.

If the EVCS determines that a collision event is likely, the EVCS can execute commands to reduce damage and/or injury. For example, to attempt to prevent the collision event the EVCS may cause speakers to play an audible alert, possibly gaining the attention of a distracted driver. The EVCS may also execute commands causing relays in the EVCS to prevent power from being transmitted from a first power source (e.g., central electrical room) to the EVCS. Accordingly, the chance of something contacting components (e.g., wires with power running through them) of the EVCS that were exposed during a collision is reduced. The EVCS may cause lights to flash in an attempt to gain the attention of a distracted driver pre-collision and/or the attention of rescue personnel (e.g., firefighter, ambulance, etc.) post-collision. The EVCS may also transmit a notification indicating that the EVCS is about to experience a collision event and/or has already experienced a collision event to alert emergency services and/or repair services. If the approaching object is an electric vehicle, the EVCS may also transmit a notification to the approaching electric vehicle indicating that the electric vehicle should slow down or stop. Upon receiving the notification, the electric vehicle may prevent the user from inadvertently hitting the EVCS.

To prevent damage or injury, an EVCS may comprise a relay coupled to a first connection point, where the first connection point receives power from a power source (e.g., central electrical room). Traditionally, a central electrical room uses one or more step-down transformers to step down the power received from powerlines until the power is at an appropriate voltage level for an EVCS. The central electrical room then transmits the power, now at the appropriate voltage level, over cables to the EVCS via the first connection point. The EVCS can use the power received from the power source to charge electric vehicles. The relay coupled to the first connection point may be have an open state and a closed state. When the relay is in the closed state, power can flow from the power source to the EVCS, and when the relay is in an open state, power is unable to flow from the power source to the EVCS. The relay may be actuated using a processor within the EVCS. The processor may be configured to receive proximal information recorded by one or more sensors located in and/or around the EVCS and process the proximal information to determine if a collision event is likely to occur. If the processor determines, using the proximal information recorded by the one or more sensors, that a collision event is likely to occur, the processor can transmit a signal and/or a current to cause the relay to switch from the closed state to the open state. Accordingly, the chance of something contacting wires with power running through them that were exposed during a collision is reduced.

The EVCS may continue to receive proximal information from the one or more sensors to determine if the EVCS has experienced the anticipated collision event. For example, if the EVCS anticipates a collision event within a first time period, the EVCS may continue to receive proximal information from a first sensor (e.g., a gyroscope affixed to the EVCS) to determine if the anticipated collision event occurred. If the first time period concludes and the EVCS determines, using proximal information, that no collision event occurred, the EVCS may execute additional commands. For example, if, in response to anticipating a collision event, the EVCS executed a first command resulting in the relay switching to an open state (e.g., EVCS not receiving power from a first source), the EVCS can issue a second command causing a signal and/or current to be transmitted to the relay, switching the relay back to the closed state. Once the relay is in the active state, the EVCS can continue to receive power from the power source. If, in response to anticipating a collision event, the EVCS sent a first notification indicating an anticipated collision event, then the EVCS can send a second notification indicating that no collision event occurred.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative diagram of a system for detecting a collision event and taking measures to reduce resulting damage and injury, in accordance with some embodiments of the disclosure;

FIG. 2 shows an illustrative block diagram of an EVCS system for detecting a collision event and taking measures to reduce resulting damage and injury, in accordance with some embodiments of the disclosure;

FIGS. 3A-3D show other illustrative diagrams of a system for detecting a collision event and taking measures to reduce resulting damage and injury, in accordance with some embodiments of the disclosure;

FIGS. 4A and 4B show other illustrative diagrams of a system for detecting a collision event and taking measures to reduce resulting damage and injury, in accordance with some embodiments of the disclosure;

FIG. 5 shows another illustrative block diagram of an EVCS system for detecting a collision event and taking measures to reduce resulting damage and injury, in accordance with some embodiments of the disclosure;

FIG. 6 shows an illustrative block diagram of a user equipment device, in accordance with some embodiments of the disclosure;

FIG. 7 shows an illustrative block diagram of a server system, in accordance with some embodiments of the disclosure;

FIG. 8 is an illustrative flowchart of a process for detecting a collision event and taking measures to reduce resulting damage and injury, in accordance with some embodiments of the disclosure;

FIG. 9 is another illustrative flowchart of a process for detecting a collision event and taking measures to reduce resulting damage and injury, in accordance with some embodiments of the disclosure; and

FIG. 10 is another illustrative flowchart of a process for detecting a collision event and taking measures to reduce resulting damage and injury, in accordance with some embodiments of the disclosure.

### DETAILED DESCRIPTION

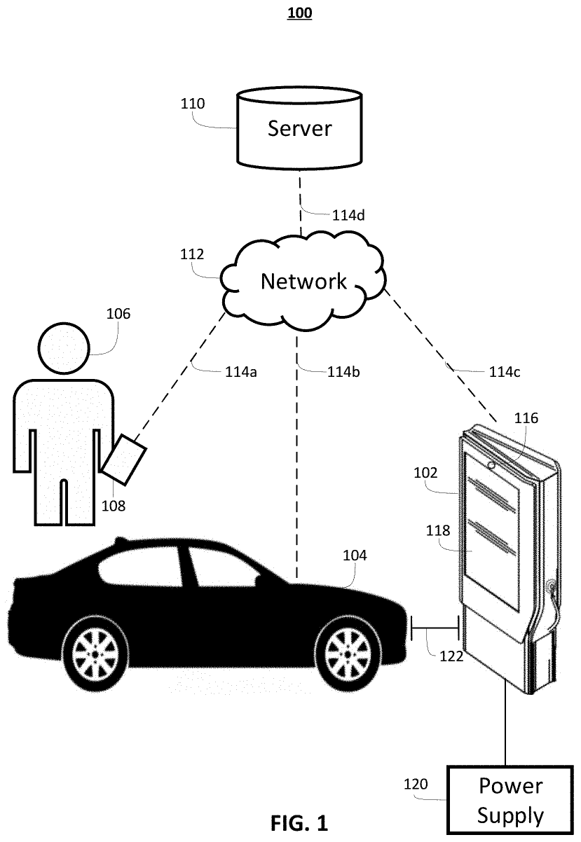

FIG. 1 shows an illustrative diagram of a system 100 for detecting a collision event and taking measures to reduce resulting damage, in accordance with some embodiments of the disclosure. In some embodiments, an EVCS 102 provides an electric charge to an electric vehicle 104 via a wired connection, such as a charging cable, or a wireless connection (e.g., wireless charging). The EVCS 102 may be in communication with the electric vehicle 104 and/or a user device 108 belonging to a user 106 (e.g., a driver, passenger, owner, renter, or other operator of the electric vehicle 104) who is associated with the electric vehicle 104. In some embodiments, the EVCS 102 communicates with one or more devices or computer systems, such as user device 108 or server 110, respectively, via a network 112. In some embodiments, the electric vehicle 104 is an autonomous electric vehicle.

In the system 100, there can be more than one EVCS 102, electric vehicle 104, user 106, user device 108, server 110, and network 112, but only one of each is shown in FIG. 1 to avoid overcomplicating the drawing. In addition, a user 106 may utilize more than one type of user device 108 and more than one of each type of user device 108. In some embodiments, there may be paths 114a-d between user devices, EVCSs, servers, and/or electric vehicles, so that the items may communicate directly with each other via communications paths, as well as other short-range point-to-point communications paths, such as USB cables, IEEE 1394 cables, wireless paths (e.g., Bluetooth, infrared, IEEE 802-11x, etc.), or other short-range communication via wired or wireless paths. In an embodiment, the devices may also communicate with each other directly through an indirect path via a communications network. The communications network may be one or more networks including the Internet, a mobile phone network, mobile voice or data network (e.g., a 4G, 5G, or LTE network), cable network, public switched telephone network, or other type of communications network or combinations of communications networks. In some embodiments, a communications network path comprises one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. In some embodiments, a communications network path can be a wireless path. Communications with the devices may be provided by one or more communications paths but is shown as a single path in FIG. 1 to avoid overcomplicating the drawing.

In some embodiments, the EVCS 102 collects information relating to the area proximal to the EVCS 102 using one or more sensors. For example, the sensors may be image (e.g., optical) sensors (e.g., one or more cameras 116), ultrasound sensors, depth sensors, IR cameras, RGB cameras, PIR cameras, thermal IR, proximity sensors, radar, tension sensors, NFC sensors, and/or any combination thereof. In some embodiments, one or more cameras 116 are configured to capture one or more images of an area proximal to the EVCS 102. For example, the camera 116 may be configured to obtain a video or capture images of an area corresponding to a parking space associated with the EVCS 102, a parking space next to the EVCS 102, and/or walking paths (e.g., sidewalks) next to the EVCS 102. In some embodiments, the camera 116 may be a wide-angle camera or a 360° camera that is configured to obtain a video or capture images of a large area proximal to the EVCS 102. In some embodiments, the camera 116 may be positioned at different locations on the EVCS 102 than that is shown. In some embodiments, the one or more sensors (e.g., camera 116) can detect external objects within a region (area) proximal to the EVCS 102. In some embodiments, the EVCS 102 transmits the captured proximal information to the server 110 and/or the user device 108.

In some embodiments, one or more sensors are constantly recording proximal information. In some embodiments, the EVCS 102 request's one or more sensors to record proximal information in response to a first input. For example, if the EVCS 102 determines that an object (e.g., electric vehicle 104) is within a threshold distance 122 of the EVCS 102, the EVCS 102 requests additional proximal information. In some embodiments, the EVCS 102 processes the proximal information recorded by the one or more sensors to determine if a collision event is likely to take place. For example, the EVCS 102 can use proximal information received from a first sensor (e.g., the camera 116) showing that the electric vehicle 104 is within the threshold distance 122 of the EVCS 102 and determine that a collision event is likely.

In some embodiments, the EVCS 102 uses information from more than one sensor to determine the likelihood of a collision event. For example, a magnetic field sensor (first sensor) may record first proximal information indicating that an object (e.g., the electric vehicle 104) is within the threshold distance 122. In response to the first proximal information received from the first sensor, the EVCS 102 can request addition proximal information from additional sensors. In some embodiments, the EVCS 102 uses the first proximal information received from the first sensor and a second proximal information received from a second sensor (e.g., the camera 116) to determine if a collision event is likely to occur. In some embodiments, the EVCS 102 uses the first and second proximal information to determine a collision event confidence score. In some embodiments, if the confidence score exceeds a first threshold, then the EVCS 102 determines that a collision event is likely and issues commands based on the confidence score. In some embodiments, proximal information received from different sensors is weighted differently. For example, proximal information received from the camera 116 may be weighted more heavily than proximal information received from the magnetic field sensor. In some embodiments, the weighting of the proximal information can relate to the reliability of the sensors (e.g., number of false positives and/or false negatives, past prediction accuracy, etc.) and/or recordable information. For example, the camera 116 may be able to capture more useful proximal information than a magnetic field sensor. In some embodiments, in response to first proximal information received from a first sensor and second proximal information received from a second sensor, the EVCS 102 requests additional proximal information from additional sensors, for example, when there are discrepancies between the first proximal information and the second proximal information and/or when additional information is required to determine if a collision event is likely.

In some embodiments, the threshold distance 122 varies based on the speed of the object (e.g., electric vehicle 104). For example, the EVCS 102 may use a first threshold distance (e.g., 30 feet) if the electric vehicle 104 is traveling a first speed (e.g., 50 miles per hour) toward the EVCS 102 and may use a second threshold distance (e.g., two feet) if the electric vehicle 104 is traveling a second speed (e.g., five miles per hour) toward the EVCS 102. In some embodiments, the EVCS 102 uses proximal information corresponding to attributes of the object (e.g., type of object, speed of the object, etc.) to determine the likelihood of a collision event. For example, the EVCS 102 may determine that if the object within the threshold distance 122 is a person then a collision event is not likely, and if the object within the threshold distance 122 is the electric vehicle 104 then a collision event is likely. In some embodiments, the EVCS 102 leverages machine learning to determine attributes of an object and/or to determine if the object is approaching the EVCS 102.

In some embodiments, if the EVCS 102 determines that a collision event is likely and/or that a collision event has occurred, the EVCS 102 executes commands to reduce damage and/or injury. In some embodiments, the EVCS 102 executes a command causing a speaker to play an audible alert, possibly gaining the attention of a distracted driver pre-collision and/or the attention of rescue personnel post-collision. In some embodiments, the speaker may be housed within or affixed to the EVCS 102. In some embodiments, the speaker is external to the EVCS 102. In some embodiments, the EVCS 102 uses more than one speaker. In some embodiments, the EVCS 102 executes a command causing a light to flash to gain the attention of a distracted driver pre-collision and/or the attention of rescue personnel post-collision. In some embodiments, the light may be the display 118, and/or may be one or more lights affixed to the EVCS 102. In some embodiments, the light is external to the EVCS 102. In some embodiments, the EVCS 102 uses more than one light. In some embodiments, the EVCS 102 executes a command causing a relay to switch, preventing power from being transmitted from a first power supply 120 (e.g., central electrical room) to the EVCS 102.

In some embodiments, if the EVCS 102 determines that a collision event is likely and/or that a collision event has occurred, the EVCS 102 transmits a notification. In some embodiments, the EVCS 102 transmits a notification, via the network 112, indicating that the EVCS 102 is about to experience a collision event and/or has experienced a collision event. In some embodiments, the notification is transmitted to the maker/owner of the EVCS 102, the user 106, emergency services, and/or repair services. In some embodiments, if the EVCS 102 determines that the electric vehicle 104 is going to collide with the EVCS 102, the EVCS 102 transmits a notification to the electric vehicle 104. In some embodiments, the notification is sent via the network 112 or similar such communication interface. In some embodiments, upon receiving the notification, the electric vehicle 104 stops, slows down, and/or alerts the user that the electric vehicle 104 is approaching the EVCS 102. In some embodiments, the notification comprises information about the object involved in the collision event. For example, if the object is the electric vehicle 104, the EVCS 102 may include vehicle information in the notification. In some embodiments, the vehicle information can include the license plate, VIN number, make, model, user driving the electric vehicle 104, etc. In some embodiments, the contents of the notification include text, audio, picture, and/or video data. In some embodiments, the object information is captured by the one or more sensors.

In some embodiments, the EVCS 102 continues to receive proximal information from the one or more sensors to determine if the EVCS 102 has experienced the anticipated collision event. For example, if the EVCS 102 anticipates a collision event within a first time period, the EVCS 102 continues to receive proximal information from a first sensor (e.g., a gyroscope affixed to the EVCS 102) to determine if the anticipated collision event occurred. In some embodiments, if the first time period concludes and the EVCS 102 determines, using proximal information, that no collision event occurred, the EVCS 102 executes additional commands. For example, if, in response to anticipating a collision event, the EVCS 102 executed a first command resulting in the relay switching to an open state (e.g., preventing power from being transmitted from the first power supply 120 to the EVCS 102), the EVCS 102 can execute a second command causing the relay to switch back to an active state. In some embodiments, if, in response to anticipating a collision event, the EVCS 102 sent a first notification indicating an anticipated collision event, then the EVCS will send a second notification indicating that no collision event occurred.

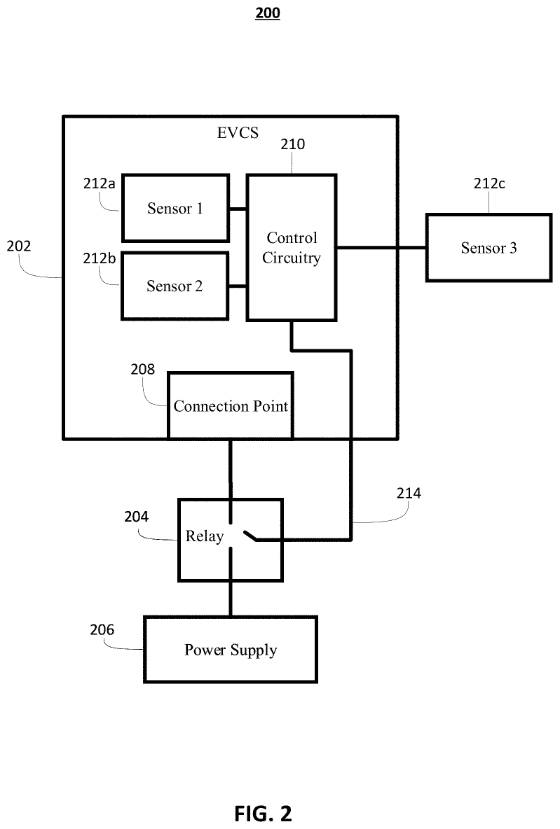

FIG. 2 shows an illustrative block diagram of an EVCS system 200 for detecting a collision event and taking measures to reduce resulting damage and injury, in accordance with some embodiments of the disclosure. In some embodiments, FIG. 2 uses the same or similar methods and devices described in FIG. 1. In practice, and as recognized by those of ordinary skill in the art, items shown separately could be combined and some items could be separated. In some embodiments, not all shown items must be included in the EVCS system 200. In some embodiments, EVCS system 200 may comprise additional items.

In some embodiments, the EVCS system 200 comprises an EVCS 202 with control circuitry 210, a connection point 208, a first sensor 212a, a second sensor 212b, and one or more input/output (I/O) paths 214. I/O paths 214 may use communication buses for interconnecting the described components. I/O paths 214 can include circuitry (sometimes called a chipset) that interconnects and controls communications between system components. EVCS 202 may receive content and data via I/O paths 214. The I/O paths 214 may provide data to control circuitry 210. The control circuitry 210 may be used to send and receive commands, requests, and other suitable data using the I/O paths 214. The I/O paths 214 may connect the control circuitry 210 to one or more communications paths. I/O functions may be provided by one or more of these communications paths but are shown as a single path in FIG. 2 to avoid overcomplicating the drawing. The control circuitry 210 may be based on any suitable processing circuitry. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

In some embodiments, the EVCS system 200 also comprises a relay 204, a power supply 206, and a third sensor 212c. In some embodiments, when the relay 204 is in a closed position, the relay 204 allows power to travel from the power supply 206 to the connection point 208. In some embodiments, when the relay 204 is in an open position, the circuit between the power supply 206 and the connection point 208 is not complete, so power cannot travel from the power supply 206 to the connection point 208. In some embodiments, when the relay 204 is in the closed position, the power passes through the connection point and is used by the EVCS 202 to perform one or more operations (e.g., charging an electric vehicle). In some embodiments, the power passes through the connection point 208 to an input transformer, where the power is adjusted to the correct voltage and/or current for the EVCS 202. Although the relay 204 is shown outside the EVCS 202, the relay 204 can be located within the EVCS 202.

In some embodiments, the relay 204 is actuated by the control circuitry 210. The control circuitry 210 can be configured to receive proximal information recorded by one or more sensors located in (e.g., first sensor 212a and second sensor 212b) and/or around (e.g., third sensor 212c) the EVCS 202 and process the proximal information to determine if a collision event is going to occur or has occurred. In some embodiments, if the control circuitry 210 determines that a collision event is going to occur or has occurred, the control circuitry 210 transmits a signal and/or a current via I/O paths 214 to the relay 204, switching the relay 204 from the closed state to the open state, preventing power from passing from the power supply 206 to the EVCS 202.

In some embodiments, the control circuitry 210 continues to receive proximal information from the one or more sensors (e.g., sensors 212a-c) to determine if the EVCS 202 has experienced the anticipated collision event. For example, if the control circuitry 210 anticipates a collision event within a first time period, the control circuitry 210 may continue to receive proximal information from the first sensor 212a (e.g., a gyroscope) to determine if the anticipated collision event occurred. In some embodiments, the one or more sensors, the control circuitry 210, and/or other components of the EVCS system 200 use power stored in a battery and/or power received from a source to continue to determine if the EVCS 202 has experienced the anticipated collision event. In some embodiments, if the control circuitry 210 determines, using proximal information received from one or more sensors (e.g., sensors 212a-c), that no collision event occurred, the control circuitry may execute commands. For example, the control circuitry 210 can issue a command causing a second signal and/or current to be transmitted to the relay 204, switching the relay 204 back to the active state. Once the relay 204 is in the active state, the EVCS 202 can continue to receive power from the power supply 206.

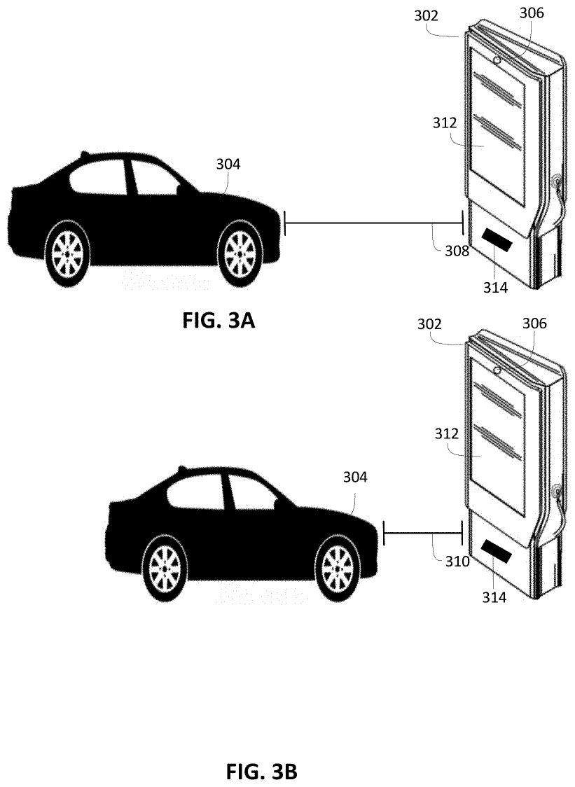

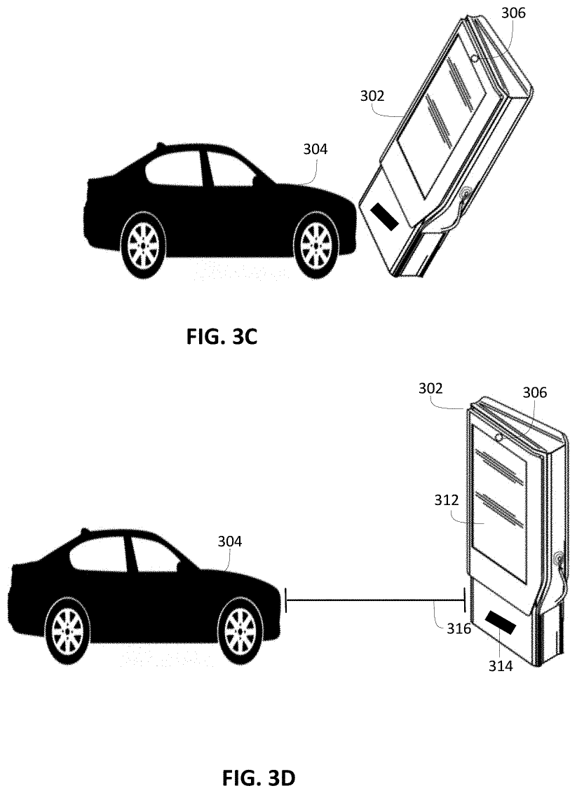

FIGS. 3A-3D show other illustrative diagrams of a system for detecting a collision event and taking measures to reduce resulting damage and injury, in accordance with some embodiments of the disclosure. In some embodiments, FIGS. 3A-3D use the same or similar methods and devices described in FIGS. 1 and 2.

FIG. 3A shows an electric vehicle 304 approaching an EVCS 302. In some embodiments, the EVCS 302 uses one or more sensors (e.g., a camera 306) to determine if the electric vehicle 304 is within a first threshold distance 308. Although an electric vehicle 304 is shown, any object (e.g., shopping cart, person, etc.) may be monitored by the EVCS 302. In some embodiments, if the EVCS 302 determines, using the camera 306, that the electric vehicle 304 is within a first threshold distance 308, the EVCS determines the likelihood of a collision event. In some embodiments, whenever an object is within the first threshold 308, the EVCS determines that a collision event is going to occur. In some embodiments, different threshold distances are used depending on the speed of the object. For example, the EVCS 302 can use the first threshold distance 308 if the electric vehicle 304 is traveling a first speed (e.g., 50 miles per hour) toward the EVCS 302. As shown by FIG. 3B, the EVCS 302 may use a second threshold distance (e.g., two feet) if the electric vehicle 304 is traveling a second speed (e.g., five miles per hour) toward the EVCS 302.

In some embodiments, whenever a first sensor (e.g., camera 306) records an object within the first threshold 308, the EVCS 302 receives information from a second senor (e.g., magnetic field sensor) to determine whether the collision event is likely to occur. In some embodiments, the EVCS 302 uses proximal information from the first and second sensors to determine a collision event confidence score. In some embodiments, as the electric vehicle 304 gets closer to the EVCS 302, the collision event confidence score increases. For example, when the electric vehicle 304 is within the second threshold distance 310, the confidence score may be higher than when the electric vehicle 304 is within the first threshold distance 308. In some embodiments, the EVCS 302 uses the proximal information to determine a first time period when the collision event is likely to take place.

In some embodiments, if the EVCS 302 determines that the collision event confidence score is above a certain threshold, the EVCS executes commands. In some embodiments, in response to the EVCS 302 determining that a collision event is likely to occur, the EVCS 302 executes a command causing a speaker 314 to play an audible alert. In some embodiments, the EVCS 302 uses more than one speaker. In some embodiments, in response to the EVCS 302 determining that a collision event is likely to occur, the EVCS 302 executes a command causing a light (e.g., a display 312) to flash. In some embodiments, the light is one or more lights affixed to the EVCS 302. In some embodiments, the light is external to the EVCS 302. In some embodiments, in response to the EVCS 302 determining that a collision event is likely to occur, the EVCS 302 executes a command causing a relay to switch, preventing power from being transmitted from a power supply to the EVCS 302. In some embodiments, in response to the EVCS 302 determining that a collision event is likely to occur, the EVCS 302 transmits a notification as described. In some embodiments, the notification comprises vehicle information (e.g., license plate, VIN number, make, model, etc.) related to the electric vehicle 304. In some embodiments, in response to the EVCS 302 determining that a collision event is likely to occur, the EVCS 302 transmits a signal to the electric vehicle 304, and the electric vehicle 304 stops. In some embodiments, the EVCS 302 issues different commands based on the distance of the electric vehicle 304 and/or the collision event confidence score. For example, the EVCS 302 may issue a first command causing the speaker 314 to play an audible alert when the electric vehicle 304 is within the first threshold distance 308 and may issue a second command causing the relay to switch when the electric vehicle 304 is within the second threshold distance 310.

FIG. 3C displays an embodiment where the anticipated collision event occurs, and FIG. 3D displays an embodiment where the anticipated collision event does not occur. In some embodiments, the EVCS 302 continues to receive proximal information from the one or more sensors to determine if the EVCS 302 has experienced the anticipated collision event. For example, the EVCS 302 may receive proximal information from a gyroscope affixed to EVCS 302 to determine if the anticipated collision event occurred. In another example, the EVCS 302 may receive proximal information from the camera 306 to determine if the anticipated collision event occurred. In some embodiments, if the EVCS 302 does experience the collision event (e.g., FIG. 3C) the EVCS 302 executes additional commands. In some embodiments, the additional commands can be any of the commands described above. In some embodiments, certain commands may be executed only if the EVCS 302 determines that the collision event occurred. For example, in some embodiments, a notification to rescue personnel may be sent only if the EVCS 302 determines that a collision event has occurred. In some embodiments, the additional commands confirm previous commands. For example, if the EVCS 302 transmitted a notification in response to anticipating a collision (e.g., FIG. 3B) indicating the likelihood of a collision, the EVCS may transmit a second notification confirming the anticipated collision.

In some embodiments, the first time period concludes and the EVCS 302 determines, using proximal information, that no collision event occurred (e.g., FIG. 3D). In some embodiments, when the electric vehicle 304 stops approaching the EVCS 302 and begins moving away from the EVCS 302, the EVCS 302 determines that the anticipated collision event will not occur. For example, if the electric vehicle 304 goes from being within the second threshold distance 310 (e.g., FIG. 3B) to being within a third threshold distance 316 (e.g., FIG. 3D), the EVCS 302 can determine that the anticipated collision event will not occur. In some embodiments, if the EVCS 302 determines, using proximal information, that no collision event occurred (e.g., FIG. 3D), the EVCS 302 executes additional commands. For example, if, in response to anticipating the collision event, the EVCS 302 executed a first command resulting in the relay switching to an open state, the EVCS 302 can execute a second command causing the relay to switch back to a closed state. In some embodiments, if, in response to anticipating the collision event, the EVCS 302 sent a first notification indicating the anticipated collision event, then the EVCS will send a second notification indicating that no collision event occurred. In some embodiments, if, in response to anticipating the collision event, the EVCS 302 caused the speaker 314 to play an alert and/or caused the display 312 to flash, then the EVCS 302 will execute a command causing the speaker 314 to stop playing the alert and/or causing the display 312 to stop flashing.

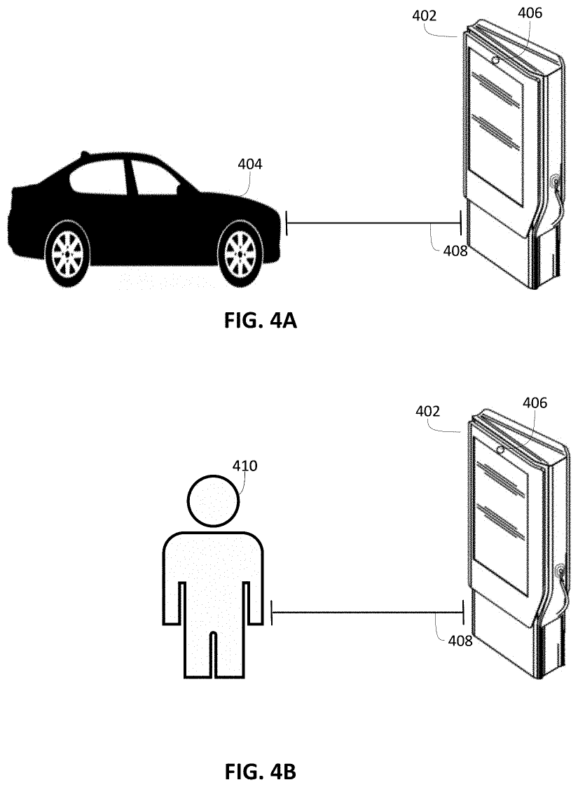

FIGS. 4A and 4B show other illustrative diagrams of a system for detecting a collision event and taking measures to reduce resulting damage and injury, in accordance with some embodiments of the disclosure.

In some embodiments, the EVCS 402 uses proximal information to determine an attribute of an object. In FIG. 4A, the EVCS 402 can receive proximal information from a first sensor (e.g., a camera 406) relating to the electric vehicle 404 (object) within the threshold distance 408. In some embodiments, the EVCS 402 uses the proximal information to determine that the object is an electric vehicle. For example, a magnetic field sensor may record a magnetic field corresponding to the electric vehicle 404, so the EVCS 402 determines that the approaching object is an electric vehicle. In some embodiments, the EVCS 402 uses machine learning to process the proximal information (e.g., video data) received from the first sensor (e.g., the camera 406) to determine that the object is an electric vehicle.

In some embodiments, the EVCS 402 uses proximal information corresponding to attributes of the object to determine the likelihood of a collision event. For example, the EVCS 402 may determine that if the object within the threshold distance 408 is an electric vehicle 404 (FIG. 4A) then a collision event is likely, and if the object within the threshold distance 408 is a person 410 (FIG. 4B) then a collision event is not likely. In some embodiments, the EVCS 402 uses more than one determined attribute of the object to determine the likelihood of a collision event. For example, the EVCS 402 may determine that the electric vehicle 404 within the threshold 408 is approaching the EVCS 402 at a first speed (e.g., two miles per hour) and does not correspond to a collision event, but a person 410 within the threshold 408, approaching the EVCS 402 at a second speed (e.g., ten miles per hour) does correspond to a collision event.

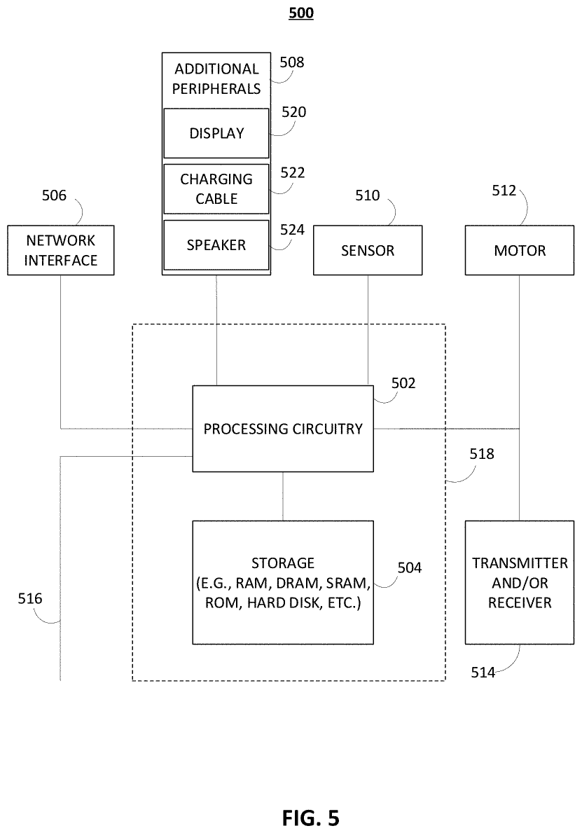

FIG. 5 shows another illustrative block diagram of an EVCS system 500 for detecting a collision event and taking measures to reduce resulting damage and injury, in accordance with some embodiments of the disclosure. In particular, the EVCS system 500 of FIG. 5 may be the EVCS depicted in FIGS. 1-4B. In practice, and as recognized by those of ordinary skill in the art, items shown separately could be combined and some items could be separated. In some embodiments, not all shown items must be included in the EVCS system 500. In some embodiments, the EVCS system 500 may comprise additional items.

The EVCS system 500 can include processing circuitry 502 that includes one or more processing units (processors or cores), storage 504, one or more network or other communications network interfaces 506, additional peripherals 508, one or more sensors 510, a motor 512 (configured to retract a portion of a charging cable), one or more wireless transmitters and/or receivers 514, and one or more I/O paths 516. I/O paths 516 may use communication buses for interconnecting the described components. I/O paths 516 can include circuitry (sometimes called a chipset) that interconnects and controls communications between system components. The EVCS system 500 may receive content and data via I/O paths 516. The I/O paths 516 may provide data to control circuitry 518, which includes processing circuitry 502 and a storage 504. The control circuitry 518 may be used to send and receive commands, requests, and other suitable data using the I/O paths 516. The I/O paths 516 may connect the control circuitry 518 (and specifically the processing circuitry 502) to one or more communications paths. I/O functions may be provided by one or more of these communications paths but are shown as a single path in FIG. 5 to avoid overcomplicating the drawing. In some embodiments, the transmitters and/or receivers 514 are used to communicate with an electric vehicle, a server, and/or a user device.

The control circuitry 518 may be based on any suitable processing circuitry such as the processing circuitry 502. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). The detecting of a collision event functionality can be at least partially implemented using the control circuitry 518. The detecting of a collision event functionality described herein may be implemented in or supported by any suitable software, hardware, or combination thereof. The detecting of a collision event functionality can be implemented on user equipment, on remote servers, or across both.

The control circuitry 518 may include communications circuitry suitable for communicating with one or more servers. The instructions for carrying out the above-mentioned functionality may be stored on the one or more servers. Communications circuitry may include a cable modem, an integrated service digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 504 that is part of the control circuitry 518. As referred to herein, the phrase “storage device” or “memory device” should be understood to mean any device for storing electronic data, computer software, or firmware, such as random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same. In some embodiments, the storage 504 includes one or more storage devices remotely located, such as database of server system that is in communication with the EVCS system 500. In some embodiments, the storage 504, or alternatively the non-volatile memory devices within the storage 504, includes a non-transitory computer-readable storage medium.

In some embodiments, storage 504 or the computer-readable storage medium of the storage 504 stores an operating system, which includes procedures for handling various basic system services and for performing hardware dependent tasks. In some embodiments, storage 504 or the computer-readable storage medium of the storage 504 stores a communications module, which is used for connecting the EVCS system 500 to other computers and devices via the one or more communication network interfaces 506 (wired or wireless), such as the Internet, other wide area networks, local area networks, metropolitan area networks, and so on. In some embodiments, storage 504 or the computer-readable storage medium of the storage 504 stores a media item module for selecting and/or displaying media items on the display(s) 520 to be viewed by passersby and users of the EVCS system 500. In some embodiments, storage 504 or the computer-readable storage medium of the storage 504 stores an EVCS module for charging an electric vehicle (e.g., measuring how much charge has been delivered to an electric vehicle, commencing charging, ceasing charging, etc.), including a motor control module that includes one or more instructions for energizing or forgoing energizing the motor. In some embodiments, executable modules, applications, or sets of procedures may be stored in one or more of the previously mentioned memory devices and corresponds to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 504 stores a subset of the modules and data structures identified above. In some embodiments, the storage 504 may store additional modules or data structures not described above.

In some embodiments, the EVCS system 500 comprises additional peripherals 508 such as displays 520 for displaying content, charging cable 522, and speaker 524. In some embodiments, the displays 520 may be touch-sensitive displays that are configured to detect various swipe gestures (e.g., continuous gestures in vertical and/or horizontal directions) and/or other gestures (e.g., a single or double tap) or to detect user input via a soft keyboard that is displayed when keyboard entry is needed. In some embodiments, the display 520 can emit visual alerts (e.g., flashing lights) in response to the EVCS system 500 anticipating and/or detecting a collision event. In some embodiments, the speaker 525 can emit audio alerts (e.g., siren, warnings, etc.) in response to the EVCS system 500 anticipating and/or detecting a collision event.

In some embodiments, the EVCS system 500 comprises one or more sensors 510 such as cameras (e.g., camera, described above with respect to FIG. 1), ultrasound sensors, depth sensors, IR cameras, RGB cameras, PIR cameras, thermal IR, proximity sensors, radar, tension sensors, NFC sensors, and/or any combination thereof. In some embodiments, the one or more sensors 510 are for detecting whether external objects are within a region proximal to the EVCS system 500, such as living and nonliving objects, and/or the status of the EVCS system 500 (e.g., available, occupied, functional, requiring repairs, etc.) in order to perform an operation, such as detecting a collision event and/or taking measures to reduce damage and injury resulting from a collision event.

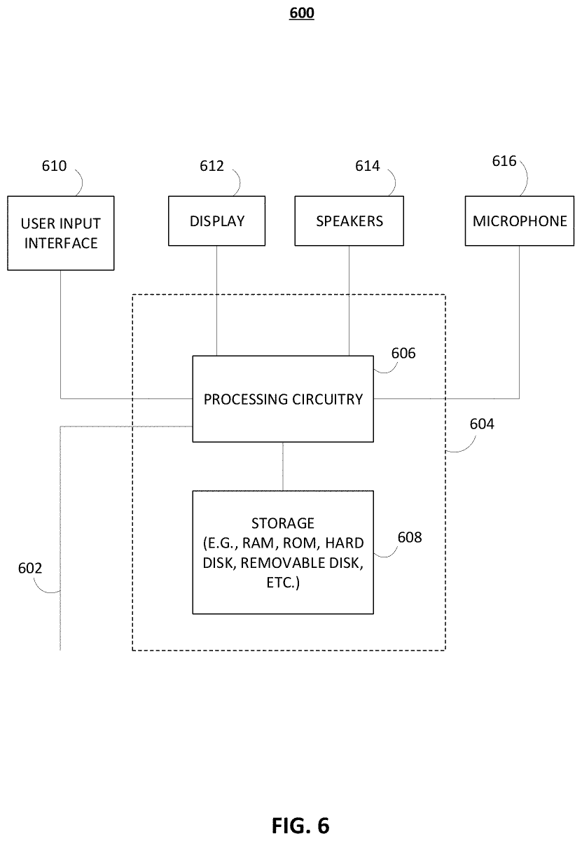

FIG. 6 shows an illustrative block diagram of a user equipment device 600, in accordance with some embodiments of the disclosure. In practice, and as recognized by those of ordinary skill in the art, items shown separately could be combined and some items could be separated. In some embodiments, not all shown items must be included in device 600. In some embodiments, device 600 may comprise additional items. In an embodiment, the user equipment device 600, is the same user equipment device displayed in FIG. 1. The user equipment device 600 may receive content and data via I/O paths 602. The I/O paths 602 may provide audio content (e.g., broadcast programming, on-demand programming, Internet content, content available over a local area network (LAN) or wide area network (WAN), and/or other content) and data to control circuitry 604, which includes processing circuitry 606 and a storage 608. The control circuitry 604 may be used to send and receive commands, requests, and other suitable data using the I/O paths 602. The I/O paths 602 may connect the control circuitry 604 (and specifically the processing circuitry 606) to one or more communications paths. I/O functions may be provided by one or more of these communications paths but are shown as a single path in FIG. 6 to avoid overcomplicating the drawing.

The control circuitry 604 may be based on any suitable processing circuitry such as the processing circuitry 606. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

In client-server-based embodiments, the control circuitry 604 may include communications circuitry suitable for communicating with one or more servers that may at least implement the described monitoring of an electric vehicle functionality. The instructions for carrying out the above-mentioned functionality may be stored on the one or more servers. Communications circuitry may include a cable modem, an ISDN modem, a DSL modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as the storage 608 that is part of the control circuitry 604. Storage 608 may include random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personnel video recorder, or PVR), solid-state devices, quantum storage devices, gaming consoles, gaming media, or any other suitable fixed or removable storage devices, and/or any combination of the same. The storage 608 may be used to store various types of content described herein. Nonvolatile memory may also be used (e.g., to launch a boot-up routine and other instructions). Cloud-based storage may be used to supplement the storage 608 or instead of the storage 608.

The control circuitry 604 may include audio generating circuitry and tuning circuitry, such as one or more analog tuners, audio generation circuitry, filters or any other suitable tuning or audio circuits or combinations of such circuits. The control circuitry 604 may also include scaler circuitry for upconverting and down converting content into the preferred output format of the user equipment device 600. The control circuitry 604 may also include digital-to-analog converter circuitry and analog-to-digital converter circuitry for converting between digital and analog signals. The tuning and encoding circuitry may be used by the user equipment device 600 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 608 is provided as a separate device from the user equipment device 600, the tuning and encoding circuitry (including multiple tuners) may be associated with the storage 608.

The user may utter instructions to the control circuitry 604 which are received by the microphone 616. The microphone 616 may be any microphone (or microphones) capable of detecting human speech. The microphone 616 is connected to the processing circuitry 606 to transmit detected voice commands and other speech thereto for processing. In some embodiments, voice assistants (e.g., Siri, Alexa, Google Home, and similar such voice assistants) receive and process the voice commands and other speech.

The user equipment device 600 may optionally include an interface 610. The interface 610 may be any suitable user interface, such as a remote control, mouse, trackball, keypad, keyboard, touch screen, touchpad, stylus input, joystick, or other user input interfaces. A display 612 may be provided as a stand-alone device or integrated with other elements of the user equipment device 600. For example, the display 612 may be a touchscreen or touch-sensitive display. In such circumstances, the interface 610 may be integrated with or combined with the microphone 616. When the interface 610 is configured with a screen, such a screen may be one or more of a monitor, a television, a liquid crystal display (LCD) for a mobile device, active matrix display, cathode ray tube display, light-emitting diode display, organic light-emitting diode display, quantum dot display, or any other suitable equipment for displaying visual images. In some embodiments, the interface 610 may be HDTV-capable. In some embodiments, the display 612 may be a 3D display. The speaker (or speakers) 614 may be provided as integrated with other elements of user equipment device 600 or may be a stand-alone unit. In some embodiments, the display 612 may be outputted through speaker 614.

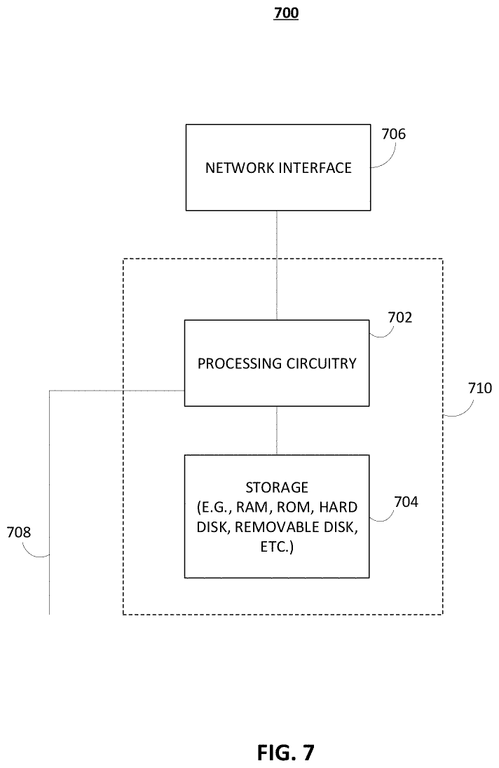

FIG. 7 shows an illustrative block diagram of a server system 700, in accordance with some embodiments of the disclosure. Server system 700 may include one or more computer systems (e.g., computing devices), such as a desktop computer, a laptop computer, and a tablet computer. In some embodiments, the server system 700 is a data server that hosts one or more databases (e.g., databases of images or videos), models, or modules or may provide various executable applications or modules. In practice, and as recognized by those of ordinary skill in the art, items shown separately could be combined, and some items could be separated. In some embodiments, not all shown items must be included in server system 700. In some embodiments, server system 700 may comprise additional items.

The server system 700 can include processing circuitry 702, which includes one or more processing units (processors or cores), storage 704, one or more network or other communications network interfaces 706, and one or more I/O paths 708. I/O paths 708 may use communication buses for interconnecting the described components. I/O paths 708 can include circuitry (sometimes called a chipset) that interconnects and controls communications between system components. Server system 700 may receive content and data via I/O paths 708. The I/O paths 708 may provide data to control circuitry 710, which includes processing circuitry 702 and a storage 704. The control circuitry 710 may be used to send and receive commands, requests, and other suitable data using the I/O paths 708. The I/O paths 708 may connect the control circuitry 710 (and specifically the processing circuitry 702) to one or more communications paths. I/O functions may be provided by one or more of these communications paths but are shown as a single path in FIG. 7 to avoid overcomplicating the drawing.

The control circuitry 710 may be based on any suitable processing circuitry such as the processing circuitry 702. As referred to herein, processing circuitry should be understood to mean circuitry based on one or more microprocessors, microcontrollers, digital signal processors, programmable logic devices, FPGAs, ASICs, etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

Memory may be an electronic storage device provided as the storage 704 that is part of the control circuitry 710. Storage 704 may include random-access memory, read-only memory, high-speed random-access memory (e.g., DRAM, SRAM, DDR RAM, or other random-access solid-state memory devices), non-volatile memory, one or more magnetic disk storage devices, optical disk storage devices, flash memory devices, other non-volatile solid-state storage devices, quantum storage devices, and/or any combination of the same.

In some embodiments, storage 704 or the computer-readable storage medium of the storage 704 stores an operating system, which includes procedures for handling various basic system services and for performing hardware dependent tasks. In some embodiments, storage 704 or the computer-readable storage medium of the storage 704 stores a communications module, which is used for connecting the server system 700 to other computers and devices via the one or more communication network interfaces 706 (wired or wireless), such as the Internet, other wide area networks, local area networks, metropolitan area networks, and so on. In some embodiments, storage 704 or the computer-readable storage medium of the storage 704 stores a web browser (or other application capable of displaying web pages), which enables a user to communicate over a network with remote computers or devices. In some embodiments, storage 704 or the computer-readable storage medium of the storage 704 stores a database for storing information on electric vehicle charging stations, their locations, media items displayed at respective electric vehicle charging stations, a number of each type of impression count associated with respective electric vehicle charging stations, user profiles, and so forth.

In some embodiments, executable modules, applications, or sets of procedures may be stored in one or more of the previously mentioned memory devices and corresponds to a set of instructions for performing a function described above. In some embodiments, modules or programs (i.e., sets of instructions) need not be implemented as separate software programs, procedures, or modules, and thus various subsets of modules may be combined or otherwise re-arranged in various implementations. In some embodiments, the storage 704 stores a subset of the modules and data structures identified above. In some embodiments, the storage 704 may store additional modules or data structures not described above.

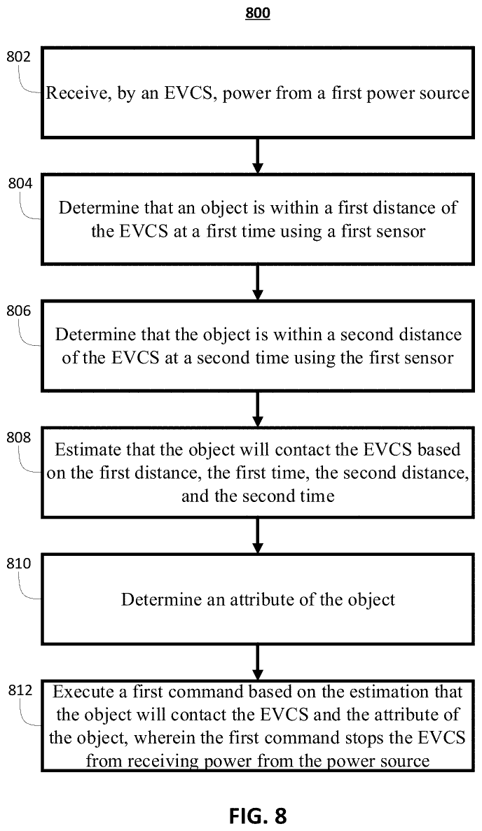

FIG. 8 is an illustrative flowchart of a process 800 for detecting a collision event and taking measures to reduce resulting damage and injury, in accordance with some embodiments of the disclosure. Process 800 may be performed by physical or virtual control circuitry, such as control circuitry 518 of EVCS (FIG. 5). In some embodiments, some steps of process 800 may be performed by one of several devices (e.g., user device 600, server system 700, etc.).

At step 802, an EVCS receives power from a power source. In some embodiments, the power source is a central electric room. In some embodiments, the power source uses one or more step-down transformers to step down the power received from powerlines until the power is at an appropriate voltage level for EVCS. In some embodiments, the power source transmits power, over one or more cables to the EVCS, and the EVCS receives the power via a connection point. In some embodiments, the EVCS uses the power received from the power source to charge electric vehicles. In some embodiments, the EVCS comprises a relay coupled to the connection point where the relay has an open state and a closed state. In some embodiments, when the relay is in the closed state, power can flow from the power source to the EVCS, and when the relay is in an open state, power is unable to flow from the power source to the EVCS.

At step 804, control circuitry determines that an object is within a first distance of the EVCS at a first time using a first sensor. In some embodiments, the control circuitry uses the first sensor to collect proximal information relating to the area proximal to the EVCS. The first sensor may be an image sensor, ultrasound sensor, depth sensor, IR camera, RGB camera, PIR camera, proximity sensor, radar, tension sensor, NFC sensor, and/or any combination thereof. In some embodiments, the first sensor is housed within the kiosk of the EVCS. In other embodiments, the first sensor is located in the area around the EVCS. The proximal information recorded by the first sensor may include time data. For example, proximal information recorded at a first time can be tagged with the first time at which it was recorded. In some embodiments, the control circuitry processes the proximal information to determine a first distance of an object in the proximal information. For example, if the proximal information is a picture, the control circuitry can use image processing to determine the first distance of the object in the picture. In some embodiments, the first sensor constantly records proximal information or is requested to record proximal information in response to some input. For example, if the control circuitry determines that an object is within a first distance of the EVCS (e.g., using a second sensor), the control circuitry can request proximal information from the first sensor. In some embodiments, using the proximal information from the first sensor, the control circuitry determines that an object is within a first distance of the EVCS at the first time.

At step 806, control circuitry determines that the object is within a second distance of the EVCS at a second time using the first sensor. In some embodiments, step 806 uses the same or similar methodologies described in step 804 above.

At step 808, control circuitry estimates the likelihood that the object will contact the EVCS based on the first distance, the second distance, the first time, and the second time. In some embodiments, the control circuitry uses the first distance, the second distance, the first time, and the second time to determine a trajectory and/or speed of the object. In some embodiments, the control circuitry uses the trajectory and/or speed of the object to determine a collision event confidence score. In some embodiments, the control circuitry uses the trajectory and/or speed of the object to determine an estimated time period when the collision event is likely to occur. In some embodiments, as the distance between the object and the EVCS decreases, the collision event confidence score increases. In some embodiments, the faster the speed of the object, the higher the collision event confidence score. In some embodiments, if the collision event confidence score exceeds a first threshold, then the control circuitry determines that the object will contact the EVCS. In some embodiments, the control circuitry uses proximal information from more than one sensor to determine the collision event confidence score. In some embodiments, the proximal information received from different sensors is weighted differently.

At step 810, control circuitry determines an attribute of the object. In some embodiments, the control circuitry uses proximal information received from the first sensor to determine an attribute of the object. For example, a magnetic field sensor may record a magnetic field corresponding to an electric vehicle, so the control circuitry determines that the object is an electric vehicle. In some embodiments, the control circuitry uses machine learning to process proximal information (e.g., video data) received from the first sensor (e.g., a camera) to determine an attribute of the object.

At step 812, control circuitry executes a first command based on the estimation that the object will contact the EVCS and the attribute of the object, wherein the first command stops the EVCS from receiving power from the power source. In some embodiments, the control circuitry uses the attribute of the object to confirm whether the estimation that the object will contact the EVCS is correct. For example, the control circuitry may determine that if an object corresponding to a determined trajectory and/or speed is an electric vehicle, then a collision event is likely, and if the object is a person, then a collision event is not likely. In some embodiments, the attribute of the object changes the collision event confidence score calculated in step 808. In some embodiments, if, based on the estimation that the object will contact the EVCS and the attribute of the object, the control circuitry determines that the collision event is likely, then the control circuitry issues a first command. The first command causes the EVCS to stop receiving power from the first power source. In some embodiments, the control circuitry transmits a signal and/or a current to the relay, switching the relay from the closed state to the open state, preventing power from passing from the power source to the EVCS. In some embodiments, the control circuitry issues additional command. For example, the control circuitry may issue a command causing speakers to play an audible alert.

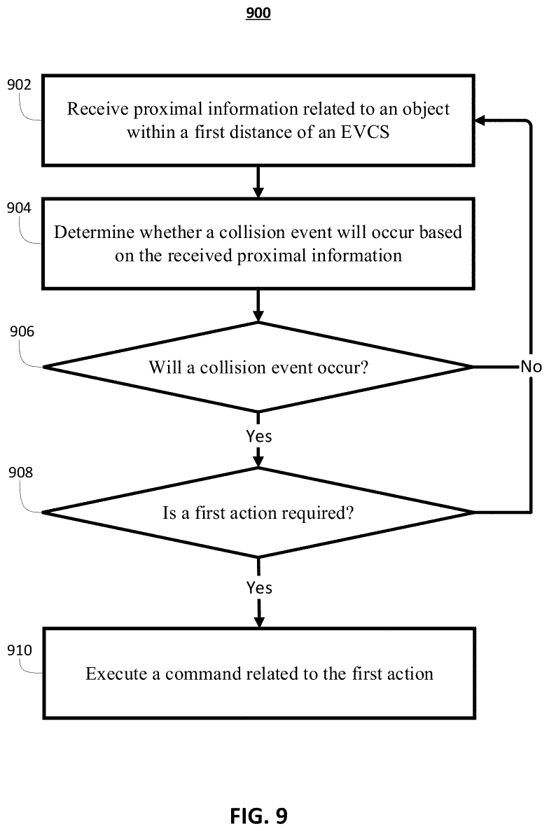

FIG. 9 is another illustrative flowchart of a process 900 for detecting a collision event and taking measures to reduce resulting damage and injury, in accordance with some embodiments of the disclosure. Process 900 may be performed by physical or virtual control circuitry, such as control circuitry 518 of EVCS (FIG. 5). In some embodiments, some steps of process 900 may be performed by one of several devices (e.g., user device 600, server system 700, etc.).

At step 902, control circuitry receives proximal information related to an object within a first distance of an EVCS. In some embodiments, the control circuitry uses one or more sensors to collect the proximal information relating to the area proximal to the EVCS. In some embodiments, the one or more sensors constantly record proximal information and send the recorded proximal information to the control circuitry. In some embodiments, the one or more sensors transmit the recorded proximal information in response to an input, for example, if the control circuitry requests the recorded proximal information and/or if the one or more sensors determine that the recorded proximal information comprises information relating to a collision event.

At step 904, control circuitry determines whether the collision event will occur based on the received proximal information. In some embodiments, the control circuitry uses the proximal information to determine a collision event confidence score. For example, if the proximal information indicates that the distance between the object and the EVCS is decreasing, the collision event confidence score may increase. In some embodiments, the control circuitry uses a threshold distance to determine if a collision event is likely to occur. In some embodiments, when the object is within the threshold distance, the collision event confidence score increases. The threshold distance may vary depending on the speed of the object. For example, the control circuitry may use a first threshold distance (e.g., 30 feet) for the object if the object is traveling a first speed (e.g., 50 miles per hour) and may use a second threshold distance (e.g., two feet) for the object if the object is traveling at a second speed (e.g., five miles per hour).

In some embodiments, the control circuitry uses proximal information to determine an attribute of the object. In some embodiments, the control circuitry uses the attribute of the object to determine the likelihood of a collision event and/or determine the collision event confidence score. For example, the control circuitry may determine that if the approaching object is a person, then a collision event is unlikely, but if the approaching object is a shopping cart, a collision event is likely. In some embodiments, if the collision event confidence score exceeds a first threshold, then the control circuitry determines that the collision event will occur. In some embodiments, the control circuitry uses proximal information from more than one sensor to determine the collision event confidence score. In some embodiments, the proximal information received from different sensors is weighted differently. In some embodiments, the control circuitry uses the proximal information to determine a first time period when the collision event is likely to take place.

At step 906, if the control circuitry determines that the collision event will occur based on the received proximal information, the process 900 continues to step 908. If the control circuitry determines that the collision event will not occur, the process returns to step 902.

At step 908, control circuitry determines whether the collision event requires a first action. If the control circuitry determines that a first action is required, the process 900 continues to step 910. If the control circuitry determines that a first action is not required, the process returns to step 902. In some embodiments, the control circuitry determines whether an action is required based on the proximal information. For example, if the control circuitry determines that the collision event will occur and the object is an electric vehicle, the control circuitry may determine that the power to the EVCS should be stopped. In another example, if the control circuitry determines that the collision event will occur and the object is a person, the control circuitry may determine that no action is required. In some embodiments, the control circuitry accesses a database with entries having one or more conditions relating to actions. For example, a first entry may specify that if an approaching object is an electric vehicle and is moving at a first speed (e.g., three miles per hour), then a first action (e.g., playing an alert through a speaker) should be taken. In some embodiments, the control circuitry determines whether an action is required based on a confidence score determined in step 904. For example, if the confidence score exceeds a first threshold, then a first action (e.g., playing an alert through a speaker) is required, and if the confidence score exceeds the first and a second threshold, a second action is also required (e.g., stopping power from going to the EVCS). In some embodiments, as the confidence score increases, the corresponding actions are increasingly severe. For example, a first action may be to play the alert at a first volume, and the second action may be to play the alert at a second louder volume.

At step 910, control circuitry executes a command related to the first action. In some embodiments, the command causes the first action. For example, the control circuitry may execute a first command causing a signal and/or a current to be transmitted to a relay and switching the relay from a closed state to an open state, preventing power from passing from the power source to the EVCS.

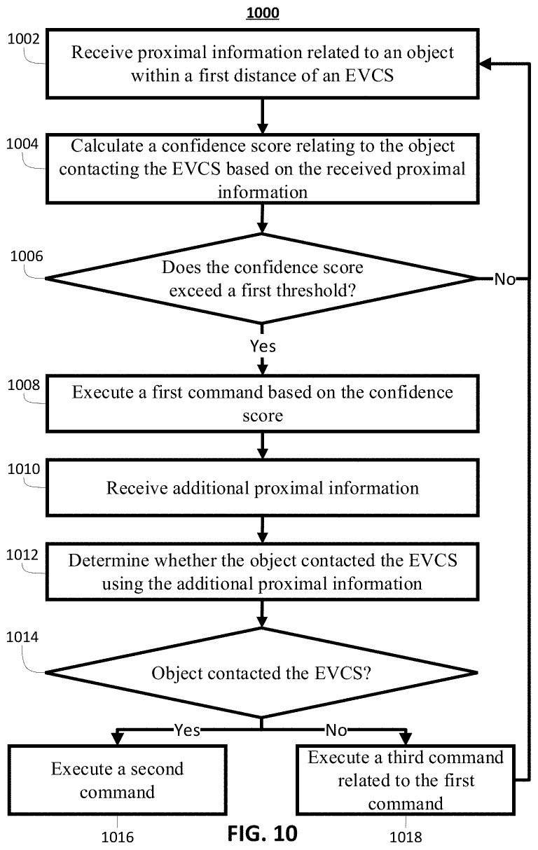

FIG. 10 is another illustrative flowchart of a process 1000 for detecting a collision event and taking measures to reduce resulting damage and injury, in accordance with some embodiments of the disclosure. Process 1000 may be performed by physical or virtual control circuitry, such as control circuitry 518 of EVCS system 500 (FIG. 5). In some embodiments, some steps of process 1000 may be performed by one of several devices (e.g., user device 600, server system 700, etc.).

At step 1002, control circuitry receives proximal information related to an object within a first distance of an EVCS. In some embodiments, the control circuitry uses one or more sensors to collect the proximal information relating to the area proximal to the EVCS. In some embodiments, the one or more sensors constantly record proximal information and send the recorded proximal information to the control circuitry. In some embodiments, the one or more sensors transmit the recorded proximal information in response to an input, for example, if the control circuitry requests the recorded proximal information and/or if the one or more sensors determine that the recorded proximal information comprises information relating to a collision event.

At step 1004, control circuitry calculates a confidence score relating to the object contacting the EVCS based on the received proximal information. In some embodiments, the confidence score is referred to as the collision event confidence score. In some embodiments, the control circuitry uses a distance of the object indicated by the proximal information to calculate/update the confidence score. For example, if the proximal information indicates that the distance between the object and the EVCS is decreasing, the collision event confidence score increases. In some embodiments, certain conditions cause a confidence score indicating a collision. For example, a condition may be that whenever a first threshold is crossed by any object, a collision event is likely. In some embodiments, the control circuitry uses a speed of the object indicated by the proximal information to calculate/update the confidence score. For example, the faster the speed of the object, the higher the collision event confidence score. In some embodiments, the control circuitry uses the type of object indicated by the proximal information to calculate/update the confidence score. For example, if the object is an electric vehicle, the collision event confidence score may be higher than if the object is a person. In some embodiments, the control circuitry uses proximal information from more than one sensor to determine the collision event confidence score. In some embodiments, the proximal information received from different sensors is weighted differently when calculating the collision event confidence score. In some embodiments, the control circuitry also uses the proximal information to determine a first time period when the collision event is likely to take place.

At step 1006, control circuitry determines whether the confidence score exceeds a first threshold. If the control circuitry determines that the confidence score exceeds a first threshold, the process 1000 continues to step 1008. If the control circuitry determines that the confidence score does not exceeds the first threshold, the process returns to step 1002. In some embodiments, the first threshold is dependent on the proximal information. For example, an object with a first speed may have a lower confidence score threshold than an object with a second, slower speed. In some embodiments, the confidence score is a binary value with a first value representing a collision and the second value representing no collision.

At step 1008, control circuitry executes a first command based on the confidence score. In some embodiments, the first command causes a display affixed to the EVCS to flash, a speaker affixed to the EVCS to play an audible alert, a relay to switch resulting in the EVCS no longer receiving power from a power source, a notification to be sent from the EVCS, and/or similar such actions. In some embodiments, the control circuitry accesses a database with entries having one or more conditions relating to actions. For example, a first entry may specify that if an approaching object is an electric vehicle and is moving a first speed (e.g., three miles per hour), then a first action (e.g., playing an alert through a speaker) should be taken. In some embodiments, if the control circuitry determines that one or more actions is required, the control circuitry executes the first command, causing the one or more actions. In some embodiments, the control circuitry determines whether an action is required based on the confidence score. For example, if the confidence score exceeds the first threshold, then a first action (e.g., playing an alert through a speaker) is required, and if the confidence score exceeds the first and a second threshold, a second action is also required (e.g., stopping power from going to the EVCS). In some embodiments, as the confidence score increases, the corresponding actions are increasingly severe. For example, a first action may be to play the alert at a first volume, and the second action may be to play the alert at a second louder volume.

At step 1010, control circuitry receives additional proximal information. In some embodiments, the control circuitry uses the same or similar methodologies as described in step 1002 to receive the additional proximal information. In some embodiments, the control circuitry requests additional proximal information from collision detection sensors. For example, a gyroscope affixed to the EVCS may normally not be recording proximal information or may rarely be recording proximal information. In response to the collision event confidence score exceeding the first threshold, the control circuitry may request additional proximal information to determine when/if the collision event has occurred.

At step 1012, control circuitry determines whether the object contacted the EVCS using the additional proximal information. For example, the control circuitry can use additional proximal information received from a gyroscope affixed to EVCS to determine if the object contacted the EVCS. In another example, the control circuitry can use additional proximal information from a camera to determine if the object contacted the EVCS. In some embodiments, if the control circuitry determines that trajectory of the object has changed and/or the object has stopped, the control circuitry determines that no object will contact the EVCS. In some embodiments, if the control circuitry determines that no collision event has occurred and the estimated collision event time period has concluded, the control circuitry determines that no object will contact the EVCS.

At step 1014, if, based on the additional proximal information, the control circuitry determines that the object contacted the EVCS, the process 1000 continues to step 1016. If, based on the additional proximal information, the control circuitry determines that the object did not contact the EVCS, the process continues to step 1018.

At step 1016, control circuitry executes a second command. In some embodiments, the second command is any of the commands described in step 1008 above. In some embodiments, the second command is executed only if the control circuitry determines that the object contacted the EVCS. For example, in some embodiments, a second command causing a notification to be transmitted to rescue personnel may be sent only if the control circuitry determines that the object contacted the EVCS. In some embodiments, the second command confirms the first command executed in step 1008 above. For example, if the first command causes a notification to be transmitted indicating the likelihood of a collision, the control circuitry can execute the second command causing a second notification to be transmitted confirming the anticipated collision. In some embodiments, the second command is based on the severity of the contact. For example, the control circuitry may use additional proximal information to determine the extent of the damage to the EVCS, the object, and/or any people. In some embodiments, if the control circuitry determines that a person was hurt during the collision event, the control circuitry will execute a second command transmitting a notification to rescue personnel indicating an injured person. In some embodiments, if the control circuitry determines that there was minimal or no damage to the EVCS, the object, and/or people, the control circuitry will execute a second command transmitting a notification indicating that no damage or injury occurred. In some embodiments, if the control circuitry determines that there was minimal or no damage to the EVCS and/or the object, the control circuitry will execute a second command switching a relay causing power to again be transmitted from a power source to the EVCS.

At step 1018, control circuitry executes a third command related to the first command. For example, if, in step 1008, the control circuitry executed the first command resulting in the relay switching to an open state, the control circuitry can execute a third command causing the relay to switch back to the closed state. In some embodiments, if, in step 1008, the control circuitry executed the first command causing a first notification indicating an anticipated collision event to be transmitted, the control circuitry will execute the third command resulting in a second notification indicating that no collision event occurred to be transmitted. In some embodiments, if, in step 1008, the control circuitry caused a speaker to play an alert and/or caused a display to flash, then the control circuitry will execute the third command causing the speaker to stop playing the alert and/or causing the display to stop flashing. The process 1000 then returns to step 1002, where the control circuitry begins the process 1000 of detecting a collision event and taking measures to reduce resulting damage and injury again.

It is contemplated that some suitable steps or suitable descriptions of FIGS. 8-10 may be used with other suitable embodiments of this disclosure. In addition, some suitable steps and descriptions described in relation to FIGS. 8-10 may be implemented in alternative orders or in parallel to further the purposes of this disclosure. For example, some suitable steps may be performed in any order or in parallel or substantially simultaneously to reduce lag or increase the speed of the system or method. Some suitable steps may also be skipped or omitted from the process. Furthermore, it should be noted that some suitable devices or equipment discussed in relation to FIGS. 1-7 could be used to perform one or more of the steps in FIGS. 8-10.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. An electric vehicle charging station comprising:
a first connection point to receive power from a power source;
a relay coupled to the first connection point, wherein when the relay is in a first state, the electric vehicle charging station receives power from the power source via the first connection point, and when the relay is in a second state, the electric vehicle charging station does not receive power from the power source via the first connection point;
a sensor configured to determine if an object is within a first distance of the electric vehicle charging station; and
a processor configured to:
determine if the object is going to contact the electric vehicle charging station using the determination made by the sensor; and
in response to determining that the object is going to contact the electric vehicle charging station, transmit a signal to the relay causing the relay to switch from the first state to the second state.

2. The electric vehicle charging station of claim 1, wherein the processor is further configured to:
determine that the object did not contact the electric vehicle within a first time period; and
in response to determining that the object did not contact the electric vehicle within a first time period, transmit a second signal to the relay causing the relay to switch from the second state to the second state.

3. The electric vehicle charging station of claim 2, wherein the processor determines that the object did not contact the electric vehicle within the first time period using a gyroscope affixed to the electric vehicle charging station.

4. The electric vehicle charging station of claim 2, wherein the processor determines that the object did not contact the electric vehicle within the first time period using an accelerometer affixed to the electric vehicle charging station.

5. The electric vehicle charging station of claim 2, wherein the processor determines that the object did not contact the electric vehicle within the first time period using a camera affixed to the electric vehicle charging station.

6. The electric vehicle charging station of claim 1, wherein the processor is further configured to, in response to determining that the object will contact the electric vehicle charging station, transmit a notification, wherein the notification indicates that the electric vehicle charging station is about to be contacted by the object.

7. The electric vehicle charging station of claim 1, wherein the processor is further configured to, in response to determining that the object will contact the electric vehicle charging station, transmit a second signal causing the electric vehicle charging station to emit an audible alert using a first speaker.

8. The electric vehicle charging station of claim 1, wherein the processor is further configured to, in response to determining that the object will contact the electric vehicle charging station, transmit a second signal causing the electric vehicle charging station to emit a visual alert using a first light.

9. The electric vehicle charging station of claim 1, wherein the sensor is a camera affixed to the electric vehicle charging station.

10. The electric vehicle charging station of claim 1, wherein the sensor is an infrared camera affixed to the electric vehicle charging station.

11. The electric vehicle charging station of claim 1, wherein the processor is further configured to determine an attribute of the object using the first sensor.

12. A method comprising:
receiving, by an electric vehicle charging station, power from a first power source, wherein the electric vehicle charging station can use the power to charge an electric vehicle when the electric vehicle is connected to the electric vehicle charging station;
determining, by the electric vehicle charging station, that an object is within a first distance of the electric vehicle charging station at a first time using a first sensor;
determining, by the electric vehicle charging station, that the object is within a second distance of the electric vehicle charging station at a second time using the first sensor;
estimating, by the electric vehicle charging station, that the object will contact the electric vehicle charging station based on the first distance, the first time, the second distance, and the second time;
determining, by the electric vehicle charging station, an attribute of the object; and
in response to estimating that the object will contact the electric vehicle charging station and determining the attribute of the object, executing, by the electric vehicle charging station, a first command, wherein the first command stops the electric vehicle charging station from receiving power from the power source.

13. The method of claim 12, further comprising;
determining, by the electric vehicle charging station, that the object did not contact the electric vehicle within a first time period;
in response to determining that the object did not contact the electric vehicle within a first time period, executing, by the electric vehicle charging station a second command, wherein the second command causes the electric vehicle charging station to begin receiving power from the power source.

14. The method of claim 13, wherein the first time period was determined using the first distance, the first time, the second distance, and the second time.

15. The method of claim 13, wherein the electric vehicle charging station determines that the object did not contact the electric vehicle within the first time period using a gyroscope affixed to the electric vehicle charging station.

16. The method of claim 13, wherein the electric vehicle charging station determines that the object did not contact the electric vehicle within the first time period using an accelerometer affixed to the electric vehicle charging station.

17. The method of claim 13, wherein the electric vehicle charging station determines that the object did not contact the electric vehicle within the first time period using a camera affixed to the electric vehicle charging station.

18. The method of claim 12, further comprising, in response to estimating that the object will contact the electric vehicle charging station and determining the attribute of the object, transmitting, by the electric vehicle charging station, a notification, wherein the notification indicates that the electric vehicle charging station is about to be contacted by the object.

19. The method of claim 12, further comprising, in response to estimating that the object will contact the electric vehicle charging station and determining the attribute of the object, executing a second command, wherein the second command causes the electric vehicle charging station to emit an audible alert using a first speaker.

20. The method of claim 12, further comprising, in response to estimating that the object will contact the electric vehicle charging station and determining the attribute of the object, executing a second command, wherein the second command causes the electric vehicle charging station to emit a visual alert using a first light.

21.-39. (canceled)
